(19) United States
(12) Patent Application Publication
(10) Pub. No.: US 2008/0005400 A1
(43) Pub. Date: Jan. 3, 2008

(54) PROGRAMMING PATH SELECTION APPARATUS AND METHOD OF WHICH

(76) Inventor: Ching-Hui Wang, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/608,246

(22) Filed: Dec. 8, 2006

(30) Foreign Application Priority Data
Jun. 7, 2006 (TW) 095209916

(51) Int. Cl. G06F 3/00

(52) U.S. Cl. 710/51

(57) ABSTRACT

A programming path selection apparatus for programming path selection is disclosed. The apparatus for selecting a programming path to one of a plurality of target modules for programming data. The programming path selection apparatus comprising: a multiplexer, coupled to a data programming apparatus and the target modules, for receiving a first control signal to select one of the programming paths as a desired programming path; and a micro processor, coupled to the multiplexer, for generating the first control signal to control the multiplexer.

### BACKGROUND OF THE INVENTION

1. Field of the Invention

The present invention relates to programming path selection apparatus, more particularly, to a programming path selection apparatus utilizing an outside control signal to select a desired programming path.

2. Description of the Prior Art

FIG. 1 illustrates a prior art data programming system 100, which comprises a data programming apparatus 101 and a target apparatus 109 having a plurality target modules (also called processing units) 111,113,115. Conventionally speaking, the data programming apparatus 101 is a computer system for transmitting data to target modules 111,113 and 115 via paths 103, 105, 107. Normally, the data are for drivers of various kinds of electronic apparatuses, while the target modules 111, 113 and 115 are the driving modules or processing units in the electronic apparatuses. For example, the EEEPROM (Electrically Erasable Programmable Read-Only Memory) can be a driving module within an electronic apparatus.

As shown in FIG. 1, the relationship between the paths 103, 105, 107 and target modules 111,113 and 115 is one to one. Therefore, the same amount of paths is needed if a plurality of target modules for programming is desired. Also, the data programming apparatus 101 and the target 109 need the same amount of connectors (not illustrated), resulting in increased circuit area and costs, which may not be justifiable in today's competitive electronic product market.

Additionally, the interface for connecting the data programming apparatus 101 and the target 109 is always a universal RS232 interface for its wide range of use. Accordingly, related products generally utilize an RS232 interface for the ISP interface, and connect the ISP interfaces one by one. Since notebook PCs do not have RS232 interfaces, the use of such interfaces become gradually reduced. Therefore, a new invention is needed to solve the above-mentioned problems.

### SUMMARY OF THE INVENTION

Therefore, one objective of the present invention is to provide a programming path selection apparatus for selecting a suitable programming path for programming data to one of a plurality of target modules. The selection is based on a control signal, and the invention is optimized to reduce consumed circuit area and related costs.

Another objective of the present invention is to provide a programming path selection apparatus, which enables data transmittal between two different interfaces in order to increase convenience.

An aspect of the invention discloses an embodiment of an apparatus for programming a path selection, which is used for selecting a programming path to program data for one of a plurality of target modules. The programming path selecting apparatus comprises: a multiplexer coupled to a data programming apparatus and the target modules for receiving a first control signal to select one of the programming paths as a desired programming path; and a micro processor coupled to the multiplexer for generating the first control signal to control the multiplexer.

The data programming apparatus can further comprise a first transmission interface, and the apparatus for programming path selecting can further comprise a second transmission interface and an interface transformation device coupled between the first transmission interface and the second transmission interface such that the data can be transmitted to the second transmission interface through the first transmission interface. The second transmission interface is a RS232 interface, while the first transmission interface is an USB interface. Also, the programming path can further comprise an infrared ray receiver, being coupled to the micro processor for receiving the second control signal from the external controller such that the micro processor generates the first control signal.

The programming path selection apparatus can further comprise an infrared ray receiver and the data programming apparatus comprises an infrared ray apparatus. The data programming apparatus is used for generating the first control signal and providing the data programmed to the target module and transmit the first control signal and the data to the infrared ray receiver via the infrared ray apparatus.

According to above-mentioned apparatus, the desired path can be selected easily, and the interface transformation device make different interfaces operate in coordination.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a prior art data programming system.

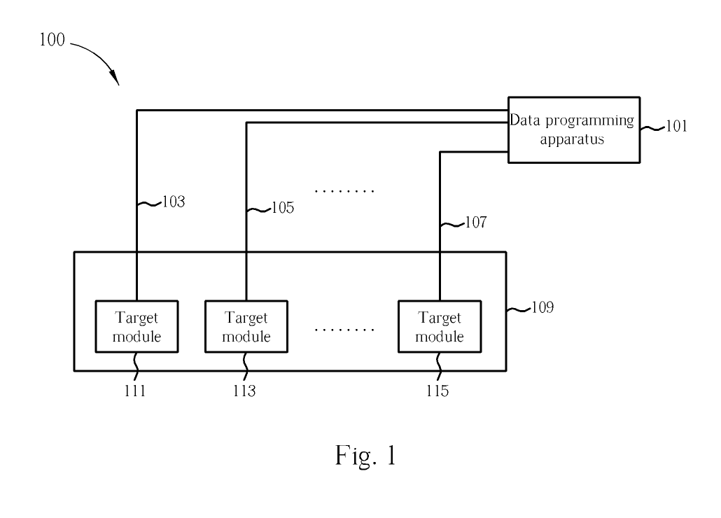

FIG. 2 is a programming path selecting apparatus according to the first preferred embodiment of the present invention.

FIG. 3 is a programming path selecting apparatus according to the second preferred embodiment of the present invention.

FIG. 4 is a programming path selecting apparatus according to the third preferred embodiment of the present invention.

### DETAILED DESCRIPTION

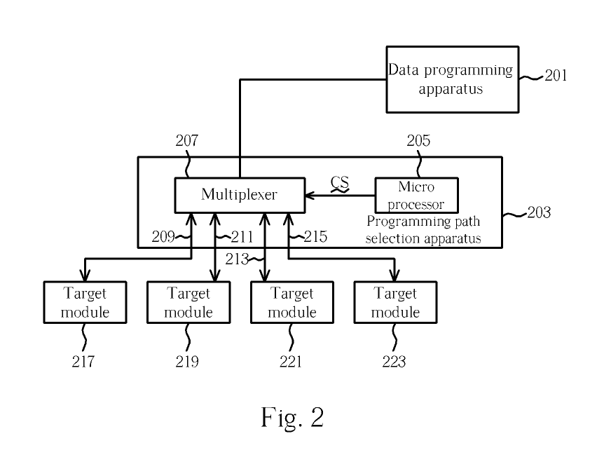

FIG. 2 is a programming path selection apparatus 203 according to the first preferred embodiment of the present invention. As shown in FIG. 2, the programming path selection apparatus 203 comprises a microprocessor 205 and a multiplexer 207. The multiplexer 207, which is coupled to the data programming apparatus 201 and the target modules 217, 219, 221, 223, is used for receiving a control signal CS to select one of the programming paths 209, 211, 213 or 215 as a desired programming path. The micro processor 205, which is coupled to the multiplexer 207, is used for generating the control signal CS to control the multiplexer 207.

In this embodiment, the programming path selection apparatus 203 is used for in system programming (ISP), and the target modules 217, 219, 221, 223 can comprise EEPROMS (Electrically Erasable Programmable Read-Only Memory). Also, the target modules 217, 219, 221, 223 can be the driver modules or processing units of the identical electronic apparatus (for example, the driver modules or processing units of a monitor), or the driver modules or processing units of different electronic apparatus. In this case, the programming data for the driver modules or processing units are the driver programs for these electronic apparatuses. However, this specific concept does not limit the present invention. The preferred operation for selecting the programming path can be shown as below. The micro processor receives the control signal CS to change the voltage level of pins of the micro processor 205, to switch the paths of the multiplexer 207 and connect the desired pin to the corresponding apparatus. It should be noted that these operational steps are meant only for exemplary purposes, and do not limit the scope of the present invention.

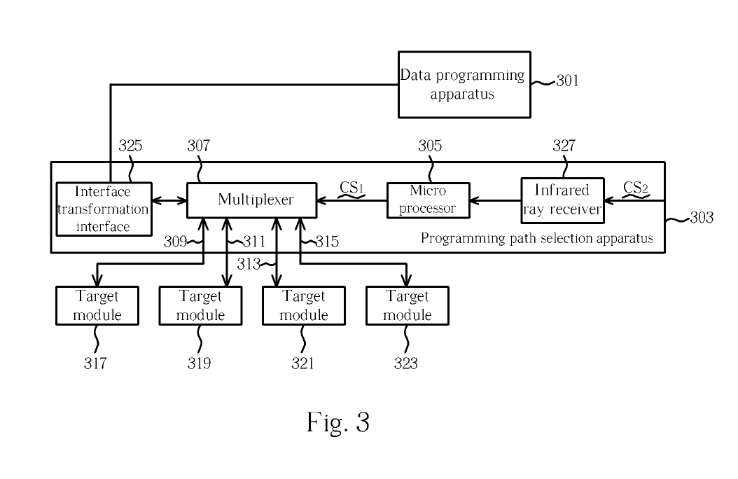

FIG. 3 is a programming path selection apparatus 303 according to the second preferred embodiment of the present invention. In comparision with FIG. 2, the programming path selection apparatus 303 further comprises an interface transformation device 325, and an infrared ray receiver 327. The interface device 325 is used to enable data transmittal between different interfaces. Normally, one interface is the programming path selecting apparatus 303, thus the data programming apparatus 301 needs a RS232 interface to cooperate with the programming path selecting apparatus 303. As techniques improve, a faster and more convenient interface, such as an USB interface, may replace the RS232 interface. However, the interface transformation device 325 is needed to negotiate between two different interfaces. In this preferred embodiment, the interface of the data programming apparatus 301 is an USB interface and the interface of the programming path selection apparatus 303 is a RS232 interface. Therefore, the interface transformation device 325 is an USB-RS232 interface transformation device. Again, this example is not meant to limit the scope of the present invention, and is detailed solely for exemplary purposes. The interface transformation device 325 can in fact be the interface transformation device between any two different interfaces as required.

In this same embodiment, the outside controller (not illustrated) is utilized for generating a second control signal CS₂, for allowing the micro-processor 305 to control the multiplexer 307. If the outside controller is an infrared ray controller, then an infrared ray receiver 327 is required to receive the second control signal CS₂. The second control signal CS2 can be transmitted to the microprocessor 305 for generating the first control signal CS₁, which is utilized to control the multiplexer 307. As described above, the outside controller can be a controller of different types, allowing the infrared ray receiver 327 to be possibly omitted.

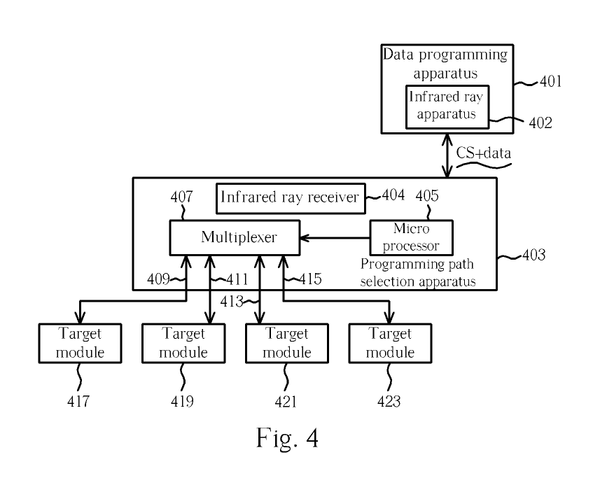

FIG. 4 is a programming path selection apparatus 403 according to the third preferred embodiment of the present invention. As shown in FIG. 4, the data programming apparatus 401 comprises an infrared ray apparatus 402. Therefore, a control signal CS can be generated by the data programming apparatus 401 to control the programming path selection apparatus 403. The control signal CS and data stored in the data programming apparatus 401 can be transmitted to the infrared ray receiver 404 via the infrared ray apparatus 402. This allows the programming data to be sent to the target modules 417, 419, 421 and 423. In this embodiment, the data programming apparatus 401 is a computer with an infrared ray apparatus, but again, is only described for exemplary purposes without limiting the scope of the present invention.

The present invention therefore provides a programming path selection apparatus. As described above, the popular USB and ISP interfaces can be utilized, allowing for easy maintenance and universal application. Also according to the above-mentioned embodiments, the terminals and the connection lines between the apparatuses can be simplified, reducing components of the RS232 interface. This benefits in reducing productions costs, circuit area, and power consumption. Additionally, the error probability associated with connecting terminals during assembly of each apparatus is greatly reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A programming path selection apparatus for selecting a programming path to program data to one of a plurality of target modules, the programming path selection apparatus comprising:
a multiplexer, coupled to a data programming apparatus and the plurality of target modules, for receiving a first control signal to select one of the programming paths as a desired programming path; and
a micro processor, coupled to the multiplexer, for generating the first control signal to control the multiplexer.

2. The apparatus of claim 1, wherein the data programming apparatus comprises a first transmission interface, and the programming path selection apparatus further comprises a second transmission interface and an interface transformation device coupled between the first transmission interface and the second transmission interface, wherein data can be transmitted to the second transmission interface from the first transmission interface.

3. The apparatus of claim 2, wherein the second transmission interface is a RS232 interface, and the first transmission interface is an USB interface.

4. The apparatus of claim 1, being used for in system programming (ISP).

5. The apparatus of claim 1, further comprising:
an external controller, for generating a second control signal to the micro processor; wherein the micro processor generates the first control signal according to the second control signal.

6. The apparatus of claim 5, further comprising an infrared ray receiver coupled to the micro processor, the infrared receiver for receiving the second control signal from the external controller.

7. The apparatus of claim 1, wherein the target modules are driver modules or processing units from an identical electronic apparatus, and the data is for driver programs.

8. The apparatus of claim 7, wherein the electronic apparatus is a display screen.

9. The apparatus of claim 1, wherein the target modules are driver modules or processing units of an identical electronic apparatus, and the data is for driver programs.

10. The apparatus of claim 1, wherein the target modules comprise EEPROMS (Electrically Erasable Programmable Read-Only Memory).

11. The apparatus of claim 1, further comprising an infrared ray receiver, and the data programming apparatus comprising an infrared ray apparatus, wherein the data programming apparatus is used for generating the first control signal and providing the data for programming to the target module and transmitting the first control signal and the data to the infrared ray receiver via the infrared ray apparatus.

12. The apparatus of claim 1, wherein the data programming apparatus is a computer.
